(19) United States
(12) Patent Application Publication
(10) Pub. No.: US 2019/0375230 A1
(43) Pub. Date: Dec. 12, 2019

(54) MECHANICAL PENCIL

(71) Applicant: KOTOBUKI & CO., LTD., Kawagoe-shi (JP)

(72) Inventor: Hidehei KAGEYAMA, Kawagoe-shi (JP)

(21) Appl. No.: 16/551,387

(22) Filed: Aug. 26, 2019

Related U.S. Application Data
(63) Continuation of application No. PCT/JP2018/014977, filed on Apr. 10, 2018.

(30) Foreign Application Priority Data
Apr. 10, 2017 (JP) 2017-077578

(51) Int. Cl. B43K 21/22; B43K 21/00; B43K 21/20

(52) U.S. Cl. CPC B43K 21/22; B43K 21/20; B43K 21/003

(57) ABSTRACT

A mechanical pencil according to an embodiment includes a barrel; a chuck mechanism that is housed inside the barrel and is capable of chucking and feeding out a writing lead for a mechanical pencil; and first and second cushion springs that elastically support the chuck mechanism in an axial direction with respect to the barrel, wherein a first cushioning region having a first spring constant and a second cushioning region having a second spring constant are formed by combining the first and second cushion springs, and the first and second cushioning regions are connected with no skipping.

### CROSS-REFERENCE TO RELATED APPLICATION

This application is based upon and claims the benefit of priority under 35 USC 119 of PCT Application No. PCT/JP2018/014977 filed on Apr. 10, 2018 (Earlier Application is Japanese Patent Application No. JP2017-077578), the entire disclosure of which, including the description, claims, drawings, and abstract, is incorporated herein by reference in its entirety.

### FIELD

This disclosure relates to a mechanical pencil that includes a chuck for chucking a writing lead for a mechanical pencil and that is capable of feeding out the writing lead for a mechanical pencil by a click operation.

### BACKGROUND

Conventionally, there is known a mechanical pencil comprising a writing lead tank slidably provided inside a barrel, a chuck fixed to a tip part of the writing lead tank, a chuck ring detachably fitted to the chuck, a sleeve provided between the barrel and the chuck, an elastic member which abuts with the sleeve and which is assembled so that a part thereof is assembled with press-fitting to the writing lead tank, and operating means which compresses the elastic member and makes the writing lead tank movable in an axial direction (for example, refer to Japanese Patent Application Laid-open No. H07-290880 (paragraphs 0006 and 0017)).

### DISCLOSURE

According to the mechanical pencil disclosed in Japanese Patent Application Laid-open No. H07-290880, a stroke for pushing out a slider can be sufficiently obtained with a simple structure which integrates a chuck fastening spring with a cushion spring into one body. However, conventionally, there is a desire to provide a mechanical pencil including a cushion spring in which a plurality of cushioning regions where cushioning is performed at different spring constants, such as one region where cushioning is performed at one spring constant in order to enable writing by absorbing excessive writing pressure and another region where cushioning is performed at another spring constant that differs from the one spring constant in order to prevent damage to a writing lead for a mechanical pencil, are connected with no skipping, for example.

This disclosure provides a mechanical pencil including a cushion spring in which a plurality of cushioning regions where cushioning is performed at different spring constants are connected with no skipping.

### SUMMARY

In an aspect of the present invention, a mechanical pencil includes a barrel, a chuck mechanism that is housed inside the barrel and is capable of chucking and feeding out a writing lead for a mechanical pencil, and first and second cushion springs that elastically support the chuck mechanism in an axial direction with respect to the barrel, wherein a first cushioning region having a first spring constant and a second cushioning region having a second spring constant are formed by combining the first and second cushion springs, and the first and second cushioning regions are connected with no skipping.

In a plurality of aspects related to the present invention, a mechanical pencil including a cushion spring in which a plurality of cushioning regions where cushioning is performed at different spring constants are connected with no skipping can be provided.

### BRIEF DESCRIPTION OF DRAWINGS

FIG. 1 is a partial sectional view illustrating a forward-side portion and a rearward-side portion while omitting an intermediate portion of a mechanical pencil according to an embodiment;

FIG. 2 is a diagram illustrating output load relative to displacement in a composite cushion spring of a mechanical pencil according to an embodiment; and

FIG. 3 is a partial sectional view illustrating a forward-side portion and a rearward-side portion while omitting an intermediate portion of a mechanical pencil according to another embodiment.

### DESCRIPTION OF EMBODIMENTS

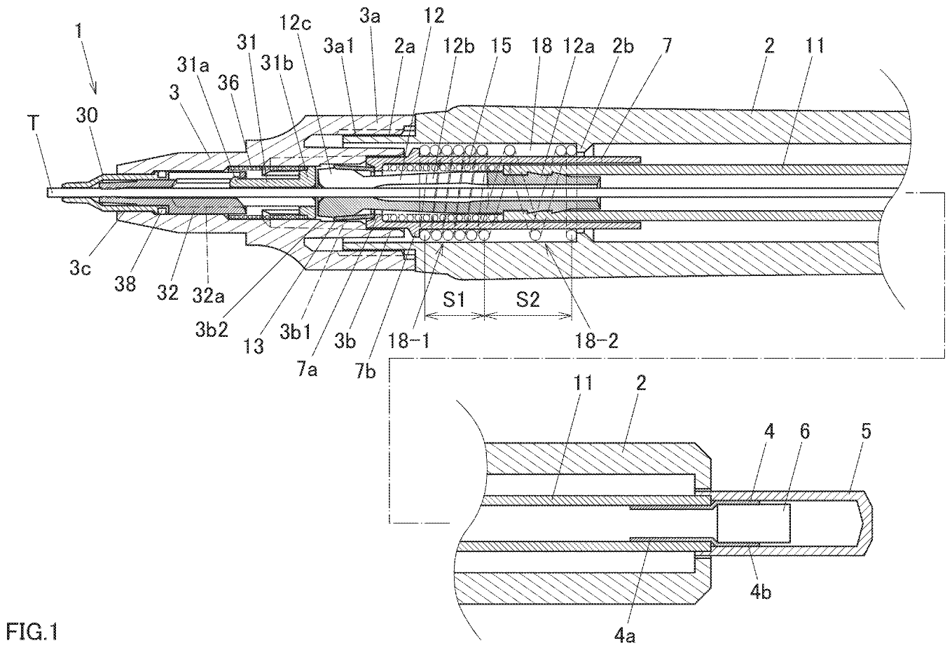

Hereinafter, a plurality of embodiments will be described with reference to the drawings. A mechanical pencil 1 according to the present embodiment illustrated in FIG. 1 is a rear end click-type mechanical pencil in which a writing lead T for a mechanical pencil is fed out and protrudes from a tip of a tip fitting 3 by a click operation on a click button 5. In the following description, a side on which the tip fitting 3 of the mechanical pencil 1 is arranged will be referred to as front and a side on which the click button 5 is arranged will be referred to as rear in a direction of a central axis (the axial direction) which extends in a longitudinal direction of the mechanical pencil 1.

The mechanical pencil 1 includes a barrel main body 2 with an approximately tubular shape and the tip fitting 3 with an approximately tapered tubular shape. A barrel is formed so as to include the barrel main body 2 and the tip fitting 3. The tip fitting 3 is arranged to the front of the barrel main body 2. A rear part of the tip fitting 3 is formed in a double tubular shape having an outer tube 3a and an inner tube 3b. The tip fitting 3 is assembled to the barrel main body 2 as an external screw part 2a formed on an outer circumferential surface of a front end part of the barrel main body 2 and an internal screw part 3a1 formed on an inner circumferential surface of the outer tube 3a to the rear of the tip fitting 3 screw with each other.

The click button 5 formed in a bottomed tubular shape is detachably attached to a rear end of a writing lead tube 11 (to be described in detail later) arranged inside the barrel main body 2. An inner circumferential surface of a front end opening of the click button 5 is detachably fitted to an outer circumferential surface of the rear end of the writing lead tube 11. An outer circumferential surface of a front part of an eraser ferrule 4 formed in an approximately tubular shape is detachably fitted and assembled to an inner circumferential surface of the rear end of the writing lead tube 11. The eraser ferrule 4 has a forward-side small diameter part 4a and a rearward-side large diameter part 4b. An outer circumferential surface of an eraser 6 is detachably fitted and assembled to an inner circumferential surface of the large diameter part 4b of the eraser ferrule 4.

The writing lead tube 11 internally housing the writing lead T for a mechanical pencil is formed in an approximately tubular shape and arranged inside the barrel main body 2. A chuck 12 is assembled to a front part of the writing lead tube 11. The chuck 12 is formed so as to be capable of chucking the writing lead T for a mechanical pencil by chucking in a radial direction when each chuck piece formed by dividing a tip of the chuck 12 into three parts in a circumferential direction elastically deforms toward the central axis. The chuck 12 has a rear end base part 12a fixed by being inserted into the writing lead tube 11, a beam-like part 12b extending forward from the base part 12a, and a bulging part 12c formed at a front end of the beam-like part 12b. A chuck ring 13 is detachably fitted to an outer circumference of the bulging part 12c. As illustrated, a sleeve 7 is arranged at an outer circumference of a front part of the writing lead tube 11 and outer circumferences of the base part 12a and the beam-like part 12b of the chuck 12.

The sleeve 7 is formed in an approximately tubular shape. An annular wall 7a is formed so as to protrude inward in the radial direction on an inner circumferential surface of a front end part of the sleeve 7. On the other hand, an annular protruding part 7b is formed so as to protrude outward in the radial direction on an outer circumferential surface of a front part of the sleeve 7. An annular protruding part 2b is formed so as to protrude inward in the radial direction on an inner circumferential surface of the barrel main body 2 so as to oppose the protruding part 7b of the sleeve 7 in the axial direction. A composite cushion spring 18 that is a compression coil spring to be compressed in the axial direction is arranged between the protruding part 7b of the sleeve 7 and the protruding part 2b of the barrel main body 2. In the composite cushion spring 18, a front end in the axial direction thereof is supported in a state where the front end abuts with the protruding part 7b of the sleeve 7 and a rear end thereof is supported in a state where the rear end abuts with the protruding part 2b of the barrel main body 2. In this manner, the composite cushion spring 18 is arranged extending in the axial direction between the sleeve 7 and the barrel main body 2. The sleeve 7 is biased forward relative to the barrel main body 2 by the composite cushion spring 18.

The composite cushion spring 18 is formed so that the number of coil windings per unit length differs between a region S1 on a forward side thereof and a region S2 on a rearward side thereof. In the present embodiment, a first wound part 18-1 that functions as the first cushion spring is formed in the region S1 and a second wound part 18-2 that functions as the second cushion spring is formed in the region S2. The composite cushion spring 18 is constituted by a combination of the first cushion spring and the second cushion spring and is integrally formed as a coil spring having the first wound part 18-1 and the second wound part 18-2. A spring constant of the first wound part 18-1 in the region S1 of which the number of coil windings per unit length is larger than in the region S2 is smaller than a spring constant of the second wound part 18-2 in the region S2 of which the number of coil windings per unit length is smaller than in the region S1. This configuration is adopted in order to make the first wound part 18-1 more deflectable with respect to the axial direction by setting the number of coil windings per unit length of the first wound part 18-1 larger than that of the second wound part 18-2 and, consequently, increasing an angle of inclination of an extending direction (a coil winding direction) of strands of the coil spring with respect to the axial direction. In the present embodiment, the first wound part 18-1 is wound at a winding pitch of approximately 0.1 mm.

A chuck spring 15 that is a coil spring is assembled between the outer circumferential surface of the beam-like part 12b of the chuck 12 and the inner circumferential surface of the sleeve 7. A front end of the chuck spring 15 abuts with a rear surface of the annular wall 7a of the sleeve 7 and a rear end of the chuck spring 15 abuts with a front end surface of the writing lead tube 11. The chuck spring 15 is assembled in a state of being compressed in the axial direction between the sleeve 7 and the writing lead tube 11. Since the writing lead tube 11 and the chuck 12 are biased rearward with respect to the sleeve 7 due to a biasing force of the chuck spring 15, the chuck ring 13 that is fitted to the chuck 12 is also biased with respect to the sleeve 7 and, as illustrated, a rear end surface of the chuck ring 13 and a front surface of the annular wall 7a of the sleeve 7 abut with each other.

A rib 3b1 extending in the axial direction is formed in plurality in the circumferential direction on an inner circumferential surface of the inner tube 3b of the tip fitting 3. A front end surface of the sleeve 7 abuts with a rear end surface of the rib 3b1 in a state of being biased forward by the composite cushion spring 18.

A step part 3b2 that can be abutted with when a front end surface of the chuck ring 13 moves forward is formed at an approximately central position in the axial direction of the rib 3b1. When the front end surface of the chuck ring 13 abuts with the step part 3b2 of the rib 3b1 formed on the inner tube of the tip fitting 3, the chuck ring 13 disengages rearward from the chuck 12 and the writing lead T for a mechanical pencil is released from the chuck of the chuck 12. A series of feed-out actuations by the mechanical pencil 1 will be described in detail later.

A guide tube 31 is arranged so as to be movable in the axial direction at a position to the front in the vicinity of the front end surface of the chuck 12. The guide tube 31 has a disk-shaped base end part 31b, a central hole into which the writing lead T for a mechanical pencil is inserted in the axial direction, and a plurality of insertion legs 31a formed around the central hole so as to protrude forward from the base end part 31b. A tip of the insertion leg 31a is formed in a hook shape as illustrated and, when engaged inside a slit 32a formed in a writing lead holder 32 to be described in detail later, the insertion leg 31a is locked so as to be relatively movable in a front-rear direction with respect to the writing lead holder 32.

A step part is formed on an outer circumferential edge of the base end part 31b of the guide tube 31. In addition, a step part of an inner circumference of the tip fitting 3 is formed on an inner circumferential surface of the tip fitting 3 that opposes the step part of the base end part 31b of the guide tube 31 in the axial direction. A return spring 36 that is a compression coil spring for biasing the guide tube 31 rearward in the axial direction with respect to the tip fitting 3 is arranged between the base end part 31b of the guide tube 31 and the step part of the inner circumference of the tip fitting 3. In a state where the guide tube 31 is biased rearward by the return spring 36, a rear end surface of the base end part 31b of the guide tube 31 approaches the front end surface of the chuck 12 from the front. In addition, when the chuck 12 moves forward, a rear end surface of the guide tube 31 abuts with a tip surface of the chuck 12 from the front. In a state where the rear end surface of the guide tube 31 approaches or abuts with the tip surface of the chuck 12 from the front, the rear end surface of the guide tube 31 supports, in a direction perpendicular to the axial direction, the writing lead T for a mechanical pencil protruding from the tip surface of the chuck 12. Therefore, a bending moment acting on a position on the tip surface of the chuck 12 in the axial direction of the writing lead T for a mechanical pencil chucked by the chuck 12 can be reduced and an occurrence of writing lead breakage of the writing lead T for a mechanical pencil at a position on the tip surface of the chuck 12 can be prevented.

The writing lead holder 32 is arranged so as to be movable in the axial direction at a position to the front of the guide tube 31. A plurality of slits 32a extending in the front-rear direction are formed on the writing lead holder 32. The tip formed in a hook shape of the insertion leg 31a of the guide tube 31 described earlier is engaged so as to be slidable inside the slit 32a. Accordingly, the guide tube 31 is locked so as to be relatively movable in the front-rear direction with respect to the writing lead holder 32. A central hole into which the writing lead T for a mechanical pencil is inserted in the axial direction is formed in the writing lead holder 32. A holding part that clamps and holds the writing lead T for a mechanical pencil inward in the radial direction is formed at a tip portion of the central hole of the writing lead holder 32. A tip tube 30 having an approximately tapered tubular shape, configured so as to be movable in the axial direction, and having an outer circumferential surface that slides against an inner circumferential surface of the opening part 3c of the tip fitting 3 to be described in detail later is arranged to the front of the writing lead holder 32. The writing lead holder 32 is inserted into the tip tube 30 from the rear and assembled to the tip tube 30.

A flange part is formed at a rear end of the tip tube 30. An 0 ring 38 that elastically supports the tip tube 30 and the writing lead holder 32 in a direction perpendicular to a direction of an axis L is assembled to an outer circumference of the flange part. The 0 ring 38 is configured so as to impart an appropriate sliding resistance with respect to movements of the tip tube 30 and the writing lead holder 32 in the front-rear direction. In this case, the appropriate sliding resistance refers to a sliding resistance capable of holding the tip tube 30 and the writing lead holder 32 so that the writing lead T for a mechanical pencil having been fed out can be held in the axial direction. In addition, the appropriate sliding resistance refers to a sliding resistance which, when a larger pressing force in the axial direction is applied to the tip tube 30 and the writing lead holder 32, allows movements of the tip tube 30 and the writing lead holder 32 so that the tip tube 30 protrudes from the tip fitting 3 or the tip tube 30 is housed inside the tip fitting 3. Forward movements of the tip tube 30 and the writing lead holder 32 are restricted as the flange part of the tip tube 30 abuts with a step part formed on the inner circumferential surface of the opening part 3c of the tip fitting.

A chuck mechanism capable of chucking and feeding out the writing lead T for a mechanical pencil is configured so as to include the chuck 12, the chuck ring 13, the sleeve 7, and the chuck spring 15, and is housed inside the barrel. In the present embodiment, the composite cushion spring 18 that is a coil spring for elastically supporting the chuck mechanism in the axial direction is set so as to have a free length. By adopting such a configuration, since writing can be performed while absorbing excessive writing pressure in accordance with the spring constant of the first cushion spring (the first wound part 18-1) of the composite cushion spring 18, high-quality writing that reflects the spring constant of the first wound part 18-1 which functions as the first cushion spring of the composite cushion spring 18 can be performed. On the other hand, when further excessive writing pressure is applied to the writing lead T for a mechanical pencil chucked by the chuck mechanism, the second wound part 18-2 with a relatively large spring constant that functions as the second cushion spring of the composite cushion spring 18 deflects and an occurrence of breakage of the writing lead T for a mechanical pencil can be prevented.

Feed-out of the writing lead T for a mechanical pencil by the mechanical pencil 1 will be described. Due to a click operation involving clicking the click button 5, the writing lead tube 11, the chuck 12 to which the chuck ring 13 is fitted, and the writing lead T for a mechanical pencil chucked by the chuck 12 move forward against a biasing force of the chuck spring 15. The guide tube 31 abutting with the chuck 12 having moved forward is also pressed forward and moves forward against a biasing force of the return spring 36. When the guide tube 31 moves forward, the writing lead holder 32 and the tip tube 30 pressed by the guide tube 31 move forward and protrude from the tip fitting 3. Once the chuck 12 and the chuck ring 13 have moved by a prescribed interval, the front end surface of the chuck ring 13 engages with the abutting surface of the step part 3b2 formed on the inner circumferential surface of the tip fitting 3, and the chuck ring 13 disengages rearward from the bulging part 12c of the chuck 12. Once the chuck ring 13 disengages, each chuck piece of the chuck 12 opens outward in the radial direction due to elasticity and the writing lead T for a mechanical pencil is released. The writing lead T for a mechanical pencil is fed out by a prescribed feed-out amount per one click operation in the mechanical pencil 1 and is then released. When the click button 5 is released from being clicked and the chuck mechanism is released from the click operation, the chuck 12 and the chuck ring 13 recede without the writing lead T for a mechanical pencil being clamped by the writing lead holder 32 at a fed-out and released position and once again chuck the writing lead T for a mechanical pencil at a position to the rear of the position prior to the click operation. In addition, when the chuck mechanism is released from the click operation and the chuck 12 and the chuck ring 13 recede, the guide tube 31 is biased by the return spring 36 and recedes.

Writing with the mechanical pencil 1 can be performed in a state where a prescribed amount of the writing lead T for a mechanical pencil is protruding from the tip tube 30. A load (so-called writing pressure) generated in the axial direction by writing is applied to the writing lead T for a mechanical pencil, the chuck 12 that chucks the writing lead T for a mechanical pencil, and the chuck ring 13 and the sleeve 7. The composite cushion spring 18 elastically deforms in accordance with the writing pressure to perform cushioning which involves the writing lead T for a mechanical pencil, the chuck 12, the chuck ring 13, and the sleeve 7 receding rearward with respect to the barrel main body 2.

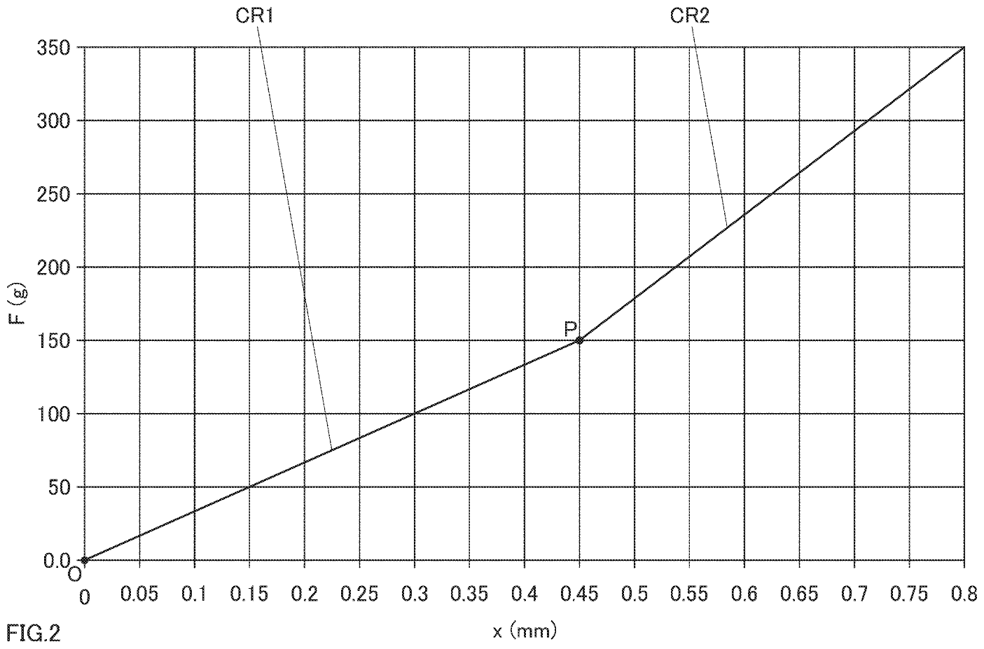

Cushioning according to the present embodiment will be described with reference to FIG. 2. FIG. 2 illustrates an specific example of a relationship between writing pressure (load) in cushioning of the mechanical pencil 1 and an amount of displacement (an amount of compression or an amount of actuation of the composite cushion spring 18) by which the chuck 12 elastically supported by the composite cushion spring 18 recedes. When writing pressure is applied to the writing lead T for a mechanical pencil, the first wound part 18-1 that is the first cushion spring of the composite cushion spring 18 is initially compressed to a greater degree and the second wound part 18-2 that is the second cushion spring is also slightly compressed. At this point, the composite cushion spring 18 is actuated in a first cushioning region CR1 indicated by a diagram from point O to point P in FIG. 2. When writing pressure of approximately 150 g is applied, the composite cushion spring 18 is compressed by approximately 0.45 mm. When writing pressure exceeds approximately 150 g, the composite cushion spring 18 is actuated in a second cushioning region CR2 indicated by the diagram at point P and thereafter in FIG. 2 in which the first wound part 18-1 that is the first spring becomes closely wound and only the second wound part 18-2 that is the second spring is actuated. When writing pressure of approximately 350 g is applied, the composite cushion spring 18 is compressed by approximately 0.8 mm.

The composite cushion spring 18 has the first spring constant in the first cushioning region CR1 and has the second spring constant that differs from the first cushioning region CR1 in the second cushioning region CR2. By combining the first and second cushion springs of the composite cushion spring 18, the first cushioning region CR1 having the first spring constant and the second cushioning region CR2 having the second spring constant are configured. As illustrated, the first cushioning region CR1 and the second cushioning region CR2 are continuously connected with no skipping (or no jumping.) In other words, an amount of compression and an output at an end point of the first cushioning region CR1 of the composite cushion spring 18 are consistent with an amount of compression and an output at a start point of the second cushioning region CR2 of the composite cushion spring 18. By adopting such a configuration, the user can use the mechanical pencil 1 without being conscious of a transition between a plurality of cushioning regions having different spring constants.

The writing lead T for a mechanical pencil is usually used when protruding from the tip tube 30 in a range of 0.45±0.15 mm. As described in the present embodiment, adopting a configuration in which the composite cushion spring 18 is compressed within a range of 0.45±0.15 mm when writing pressure is applied in a range of 150±50 g is preferable since an ordinary writing state in which the writing lead T for a mechanical pencil is protruded from the tip tube 30 can be made to approximately coincide with the first cushioning region CR1 of the composite cushion spring 18. In this case, the first cushioning region CR1 and the second cushioning region CR2 are connected with no skipping at one actuation point where the combined first and second cushion springs are compressed within a range of 0.45±0.15 mm when writing pressure is applied in a range of 150±50 g. In addition, for example, a configuration is more favorably adopted in which the composite cushion spring 18 is compressed within a range of 0.45±0.09 mm when writing pressure is applied in a range of 150±30 g, and a configuration is most favorably adopted in which the composite cushion spring 18 is compressed within a range of 0.45±0.03 mm when writing pressure is applied in a range of 150±10 g. When the amount of actuation (the amount of compression) of the composite cushion spring 18 is larger than an amount of protrusion of the writing lead T for a mechanical pencil from the tip tube 30, as long as the tip tube 30 and the writing lead holder 32 of which the tips come into contact with a writing surface are capable of receding, the tip tube 30 and the writing lead holder 32 recede and the amount of actuation (the amount of compression) of the composite cushion spring 18 is secured. The tip tube 30 and the writing lead holder 32 recede while protecting the writing lead T for a mechanical pencil, and when writing pressure is removed, and the composite cushion spring 18 is restored to its free length, the writing lead T for a mechanical pencil once again protrudes from the tip tube 30.

In addition, as described in the present embodiment, a configuration in which the composite cushion spring 18 is compressed within a range of 0.8±0.11 mm when writing pressure is applied in a range of 350±50 g may be adopted. This configuration is preferable because an end point assumed for the purpose of ordinary writing in the second cushioning region CR2 of the composite cushion spring 18 can be set to an amount of displacement at which the user can readily be conscious of an increase in cushion stroke and, at the same time, writing pressure can be set to a level where breakage of the writing lead T for a mechanical pencil can be prevented. In this case, the second cushioning region CR2 includes one actuation point where the combined first and second cushion springs are compressed within a range of 0.8±0.11 mm when writing pressure is applied in a range of 350±50 g. Furthermore, for example, a configuration is more favorably adopted in which the composite cushion spring 18 is compressed within a range of 0.8±0.07 mm when writing pressure is applied in a range of 350±30 g, and a configuration is most favorably adopted in which the composite cushion spring 18 is compressed within a range of 0.8±0.02 mm when writing pressure is applied in a range of 350±10 g.

Moreover, in another embodiment, a configuration may be adopted in which the spring constant of the second cushioning region CR2 is configured lower than in the present embodiment and the end point assumed for ordinary writing is positioned within the second cushioning region CR2 when the composite cushion spring 18 is compressed by approximately 1.5 mm. In this case, in the second cushioning region CR2 which has a longer cushion stroke, the user can perform high-quality writing that reflects the spring constant of the second cushion spring (the second wound part 18-2) of the composite cushion spring 18 in addition to preventing breakage of the writing lead T for a mechanical pencil.

In this manner, a mechanical pencil including a cushion spring in which a plurality of cushioning regions where cushioning is performed at different spring constants are connected with no skipping can be provided. Since the composite cushion spring 18 is integrally formed as a coil spring having the first wound part 18-1 and the second wound part 18-2 with different numbers of windings, the composite cushion spring 18 can be preferably formed with a smaller number of parts. In addition, since the composite cushion spring 18 is set so as to have a free length, as shown in FIG. 2, cushioning can be performed in an entire range of actuation of the composite cushion spring 18 including point O.

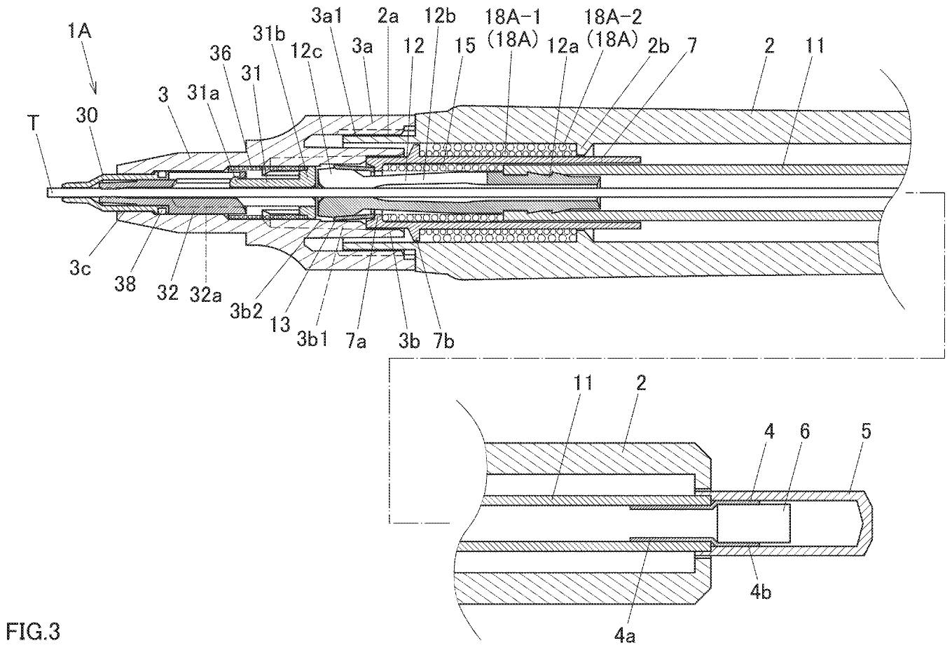

A mechanical pencil 1A according to another embodiment will now be described with reference to FIG. 3. The mechanical pencil 1A shares the same configuration as the mechanical pencil 1 described above with the exception of a configuration of a composite cushion spring 18A. Therefore, only the composite cushion spring 18A will be described and overlapping descriptions of the mechanical pencil 1A will be omitted. The composite cushion spring 18A of the mechanical pencil 1A has a first cushion spring 18A-1 with a relatively small diameter and a second cushion spring 18A-2 with a relatively large diameter and being arranged on an outer circumference of the first cushion spring 18A-1, the first cushion spring 18A-1 and the second cushion spring 18A-2 being respectively formed as separate bodies. In this manner, the first cushion spring 18A-1 and the second cushion spring 18A-2 respectively formed as separate bodies may be arranged in parallel to constitute the composite cushion spring 18A. On the other hand, with the composite cushion spring 18 of the mechanical pencil 1 according to the embodiment described earlier, the first cushion spring thereof (the first wound part 18-1) and the second cushion spring thereof (the second wound part 18-2) are arranged in series.

The first cushion spring 18A-1 and the second cushion spring 18A-2 of the composite cushion spring 18A according to the present embodiment respectively have different spring constants. In the first cushion spring 18A-1 wound at a prescribed equal pitch, a front end in the axial direction thereof is supported in a state where the front end abuts with the protruding part 7b of the sleeve 7 and a rear end thereof is supported in a state where the rear end abuts with the protruding part 2b of the barrel main body 2. In the second cushion spring 18A-2 wound at another prescribed equal pitch, while a rear end in the axial direction thereof is supported in a state where the rear end is bonded to a front surface of the protruding part 2b of the barrel main body 2, a front end thereof is arranged so as not to abut with the protruding part 7b of the sleeve 7. By adopting such a configuration, only the first cushion spring 18A-1 is actuated in an initial stage of actuation of the composite cushion spring 18A. When writing pressure is further applied, after the first cushion spring 18A-1 elastically deforms by a prescribed amount and is actuated, a tip of the second cushion spring 18A-2 abuts with a rear surface of the protruding part 7b of the sleeve 7. Subsequently, when writing pressure is further applied, both the first cushion spring 18A-1 and the second cushion spring 18A-2 elastically deform and are actuated. Therefore, a mechanical pencil including a cushion spring in which a plurality of cushioning regions where cushioning is performed at different spring constants are connected with no skipping can be provided.

A relationship between writing pressure (load) in cushioning of the composite cushion spring 18A and an amount of displacement (an amount of compression or an amount of actuation of the composite cushion spring 18A), by which the chuck 12 elastically supported by the composite cushion spring 18A recedes, according to the present embodiment is similar to that of the mechanical pencil 1 described earlier and shown in FIG. 2. When writing pressure is applied to the writing lead T for a mechanical pencil, in the composite cushion spring 18A, only the first cushion spring 18A-1 is initially compressed and the second cushion spring 18-2 is not actuated. At this point, the composite cushion spring 18A is actuated in the first cushioning region CR1 indicated by a diagram from point O to point P in FIG. 2. When writing pressure is applied up to approximately 150 g, the composite cushion spring 18A is compressed by approximately 0.45 mm. When writing pressure exceeds approximately 150 g, since the second cushion spring (the second wound part 18-2) is actuated together with the first cushion spring (the first wound part 18-1), the composite cushion spring 18A is actuated in the second cushioning region CR2 indicated by the diagram at point P and thereafter in FIG. 2. The spring constant in the second cushioning region CR2 of the composite cushion spring 18A is configured larger than the spring constant in the first cushioning region CR1 of the composite cushion spring 18A. Therefore, the user can readily comprehend an actuation of the composite cushion spring 18A in the second cushioning region CR2 by a rate of increase of writing pressure (spring constant) during writing. When writing pressure of approximately 350 g is applied, the composite cushion spring 18A is compressed by approximately 0.8 mm.

While a plurality of embodiments of the present invention have been described above, it is to be understood that the present invention is not limited to the embodiments and can be implemented with a wide variety of modifications. For example, in the embodiment presented earlier, the composite cushion spring 18 has been described so as to include a coil spring having a first wound part 18-1 and a second wound part 18-2. However, this configuration is not restrictive and a composite cushion spring may be configured by arranging a first cushion spring and a second cushion spring formed as separate bodies in series. In addition, for example, a configuration may be adopted in which the spring constant of the first wound part 18-1 is larger than the spring constant of the second wound part 18-2. In this manner, the first and second cushion springs arranged in series may be arbitrarily interchanged and arranged. Furthermore, in addition to the first and second cushion springs described above, a composite cushion spring may be configured so as to have two or more arbitrary cushion springs and to be actuated by combining the cushion springs. In addition, while a composite cushion spring has been described so as to be formed as a coil spring, this configuration is not restrictive and resin, rubber, or the like having elasticity may be molded in an arbitrary shape and used.

What is claimed is:

1. A mechanical pencil, including:
a barrel;
a chuck mechanism that is housed inside the barrel and is capable of chucking and feeding out a writing lead for a mechanical pencil; and
first and second cushion springs that elastically support the chuck mechanism in an axial direction with respect to the barrel, wherein
a first cushioning region having a first spring constant and a second cushioning region having a second spring constant are formed by combining the first and second cushion springs, and the first and second cushioning regions are connected with no skipping.

2. The mechanical pencil according to claim 1, wherein the first and second cushion springs are integrally formed as a coil spring having first and second wound parts.

3. The mechanical pencil according to claim 1, wherein the first and second cushion springs are set so as to have a free length.

4. The mechanical pencil according to claim 2, wherein the first and second cushion springs are set so as to have a free length.

5. The mechanical pencil according to claim 1, wherein the first cushioning region and the second cushioning region are connected at one actuation point, where the combined first and second cushion springs are compressed within a range of 0.45±0.15 mm, when writing pressure is applied in a range of 150±50 g.

6. The mechanical pencil according to claim 2, wherein the first cushioning region and the second cushioning region are connected at one actuation point, where the combined first and second cushion springs are compressed within a range of 0.45±0.15 mm, when writing pressure is applied in a range of 150±50 g.

7. The mechanical pencil according to claim 3, wherein the first cushioning region and the second cushioning region are connected at one actuation point, where the combined first and second cushion springs are compressed within a range of 0.45±0.15 mm, when writing pressure is applied in a range of 150±50 g.

8. The mechanical pencil according to claim 4, wherein the first cushioning region and the second cushioning region are connected at one actuation point, where the combined first and second cushion springs are compressed within a range of 0.45±0.15 mm, when writing pressure is applied in a range of 150±50 g.

9. The mechanical pencil according to claim 1, wherein the second cushioning region includes one actuation point, where the combined first and second cushion springs are compressed within a range of 0.8±0.11 mm, when writing pressure is applied in a range of 350±50 g.

10. The mechanical pencil according to claim 2, wherein the second cushioning region includes one actuation point, where the combined first and second cushion springs are compressed within a range of 0.8±0.11 mm, when writing pressure is applied in a range of 350±50 g.

11. The mechanical pencil according to claim 3, wherein the second cushioning region includes one actuation point, where the combined first and second cushion springs are compressed within a range of 0.8±0.11 mm, when writing pressure is applied in a range of 350±50 g.

12. The mechanical pencil according to claim 4, wherein the second cushioning region includes one actuation point, where the combined first and second cushion springs are compressed within a range of 0.8±0.11 mm, when writing pressure is applied in a range of 350±50 g.

13. The mechanical pencil according to claim 5, wherein the second cushioning region includes one actuation point, where the combined first and second cushion springs are compressed within a range of 0.8±0.11 mm, when writing pressure is applied in a range of 350±50 g.

14. The mechanical pencil according to claim 6, wherein the second cushioning region includes one actuation point, where the combined first and second cushion springs are compressed within a range of 0.8±0.11 mm, when writing pressure is applied in a range of 350±50 g.

15. The mechanical pencil according to claim 7, wherein the second cushioning region includes one actuation point, where the combined first and second cushion springs are compressed within a range of 0.8±0.11 mm, when writing pressure is applied in a range of 350±50 g.

16. The mechanical pencil according to claim 8, wherein the second cushioning region includes one actuation point, where the combined first and second cushion springs are compressed within a range of 0.8±0.11 mm, when writing pressure is applied in a range of 350±50 g.
